(19) United States
(12) Patent Application Publication
(10) Pub. No.: US 2005/0084829 A1
(43) Pub. Date: Apr. 21, 2005

(54) Tools and method for acquiring foreign languages

(75) Inventor: Erik Peters, Fujisawa-shi (JP)

Correspondence Address: FITCH, EVEN, TABIN & FLANNERY, P. O. BOX 65973, WASHINGTON, DC, 20035, US

(73) Assignee: TransVision Company, Limited, Fujisawa-shi (JP)

(21) Appl. No.: 10/953,570

(22) Filed: Sep. 30, 2004

(30) Foreign Application Priority Data
Oct. 21, 2003 (JP) JP 2003-360650

(51) Int. Cl. G09B 7/00; G09B 19/06; G09B 19/08

(52) U.S. Cl. 434/157; 434/323

(57) ABSTRACT

As shown in FIG. 1, Foreign languages are effectively learned and taught by using the tools, My Language Toolbox comprising My English Targets as an example of the material to set the target of study; My Lesson Plan as an example of the material to make the plan of study; My Dictionary as an example of the learner-making dictionary; My Speaking Mistakes as an example of the material for speaking; My Listening as an example of the material for listening; My Pronunciation as an example of the material for pronunciation; My Grammar as an example of the material for grammar; My Writing as an example of the material for writing; My Letter as an example of the material for the letter; My Reading as an example of the material for reading; My Homework as an example of the material for motivating, tracking and confirming the independent study; My Test as an example of the material for testing the skill, the unknown word, the unknown phrase and the mistake; and My Skills Report as an example of the material for reporting and analyzing the progress. With the tool, the learners are able to understand their purpose, have clear language targets to be achieved within a set period of time, and know how they will achieve those targets. The tools and method allow for the recording, identification, categorization, correction, analysis, and historical tracking of new words, phrases, and mistakes of their own language usage.

### BACKGROUND OF THE INVENTION

The present invention relates to novel and effective tools and method for teaching and learning foreign languages.

There has been a lot of proposals for teaching and learning foreign languages. For example, Richards and Rodgers reviewed the history, content and analysis of major methods for Second Language Acquisition (SLA) in their book “Approaches and Methods in Language Teaching: A description and analysis. 2nd Edition” (Jack C. Richards & Theodore S. Rodgers, 2001, Cambridge University Press). In addition, Rod Ellis provided a comprehensive explanation of SLA theories in his book “Understanding Second Language Acquisition” (1985, Longman).

However, there seems to be no identification and no validation of clearly defined student learning targets connected to building a lesson plan based on the selected targets followed up by measurement and confirmation of the achievement of the targets within a set period of time.

Nor has likely there existed a framework for identifying weakness and mistakes and then recording and then prompting the student to learn the correction. Nor seems to exist a system that tracks the students' mistakes and provides analysis and learning of the mistakes.

In the conventional language class, instructors commonly correct a student when they make a mistake, and may even prompt the student to write down the corrected language, however, after that point the mistake and correction generally become the responsibility of the student and may or may not revisited in future classes.

Further, in the conventional class the instructor may introduce vocabulary, and the vocabulary may or may not be tested in future classes, however after its first introduction, vocabulary that is new to the student and the mistakes made are often times not accessible to the instructor and not tested, especially when only the student records the information pertinent to themselves. And the language point may be simply lost if neither the instructor nor student identify or records the information.

Common approaches to teaching are teaching of preplanned content, teaching set lesson plans, not teaching based on any lesson plans, or following lesson plans contained in a textbook. No likely method or tools exist for culling, tracking and teaching based on the students' mistakes made while studying planned or unplanned lesson content.

In a single one-hour lesson a student will make one to many number of mistakes and encounter one to many numbers of unknown words and phrases. These mistakes and unknown words and phrase accumulate in even larger numbers the longer the lesson and course. With no record, tracking and teaching of mistakes, new words, and new phrases valuable learning is lost and the learning process slowed.

### SUMMARY OF THE INVENTION

As set forth above, it is an object of the present invention to provide novel and effective tools and method for teaching and learning foreign languages.

In light of the above problems, the present invention provides a tool for acquiring a foreign language, comprising at least one of:
a material to set a target of study;
a material to make a plan of study;
a learner-making dictionary; a material for speaking; a material for listening; a material for pronunciation; a material for grammar; a material for writing; a material for a letter; a material for reading; in order to record, identify, analyze, correct, learn, memorize and use an unknown word, an unknown phrase and a mistake;
a material for motivating, tracking and confirming an independent study;
a material for testing a skill, the unknown word, the unknown phrase and the mistake; and
a material for reporting and analyzing a progress.

The present invention also provides the tool described above, wherein all of the materials are contained and at least two of the materials are connected so that the unknown word, the unknown phrase and the mistake in at least one of the materials appear on at least one of the other materials.

The present invention also provides the tool described above, wherein at least one of the materials utilize an electronic device.

The present invention also provides the tool described above, wherein at least one of the materials comprise an implementing section and a correcting section of the unknown word, the unknown phrase and the mistake.

The present invention also provides a method for acquiring a foreign language using the tool described above, comprising:
setting the target of study using the material to set the target of study;
making the plan of study using the material to make the plan of study;
recording, identifying, analyzing, correcting, learning, memorizing and using the unknown word, the unknown phrase and the mistake; using at least one of the learner-making dictionary, the material for speaking, the material for listening, the material for pronunciation, the material for grammar, the material for writing, the material for the letter and the material for reading;
motivating, tracking and confirming the independent study using the material for motivating, tracking and confirming the independent study;
testing the skill, the unknown word, the unknown phrase and the mistake using the material for testing the skill, the unknown word, the unknown phrase and the mistake; and
reporting and analyzing the progress using the material for reporting and analyzing the progress.

With the tools and method of the present invention, language learners are able to understand their purpose, have clear language targets to be achieved within a set period of time, and know how they will achieve those targets. They also have for the first time, tools that allow for the recording, identification, categorization, correction, analysis, and historical tracking of new words, phrases, and mistakes of their own language usage. The tool allows students to see their mistakes and use the tools to learn how to correct them and use new words, phrases and mistakes correctly in the language in at least one of the speaking skill, the listening skill and the writing skill.

The present invention achieves the identification and validation of clearly defined student learning targets connected to building a lesson plan based on the selected targets followed up by measurement and confirmation of the achievement of the targets within a set period of time.

The tools and methods achieve teaching based on and using the students' mistakes and what is new to the student. New words and new phrases particular to a student and students' mistakes are used and tracked in further studies. For example, what is new to the student appears in the learner-making dictionary, the material for speaking, the material for listening, the material for pronunciation, the material for grammar, the material for writing, the material for a letter and the material for reading. In addition, what is new to the student is reflected in the material to set a target of study, the material to make a plan of study, the material for motivating, tracking and confirming an independent study, the material for testing a skill, the unknown word, the unknown phrase and the mistake, and the material for reporting and analyzing a progress.

The present invention also achieves a framework for identifying weakness and mistakes and then recording and then prompting the student to learn the correction. In addition the present invention achieves a system that tracks the students' mistakes and provides analysis and learning of the mistakes.

The present invention also achieves a effective tracking of mistakes and new words and new phrases and link between new words or phrases and their usage.

The present invention also achieves culling, tracking and teaching based on the students mistakes made while studying planned or unplanned lesson content.

To more effectively complete the above-mentioned achievements, the mistakes and/or the analysis of the mistakes may be matched to learning content that instructs or teaches the points of the mistakes made by the student.

Further, in the Dictionary, Grammar, Paragraph, and Letter, the minimum length of the sentences to be created by the student may be assigned. For example, the sentence must be at least 6 words in length.

Furthermore, in pronunciation description, the mistake may be preserved in its mistaken form with the proper form written next to it so the student can compare the two and clearly see the difference between them.

In addition, in the tools, the mistakes may be captured and or displayed in writing, or in audio, or video.

### BRIEF DESCRIPTION OF THE DRAWINGS

FIG. 1 shows an example of the content of the tool.

FIG. 2 shows an example of the usage of the tool.

FIGS. 3A and 3B show examples of a preferred embodiment of the material to set the target of study.

FIGS. 4A and 4B show examples of a preferred embodiment of the material to make the plan of the study.

FIG. 5 shows an example of a preferred embodiment of the learner-making dictionary.

FIGS. 6A to 6D show examples of a preferred embodiment of the material for speaking.

FIGS. 7A and 7B show examples of a preferred embodiment of the material for listening.

FIG. 8 shows an example of a preferred embodiment of the material for pronunciation.

FIGS. 9A and 9B show examples of a preferred embodiment of the material for grammar.

FIGS. 10A to 10D show examples of a preferred embodiment of the material for writing.

FIG. 11 shows an example of a preferred embodiment of the material for the letter.

FIG. 12 shows an example of a preferred embodiment of the material for reading.

FIG. 13 shows an example of a preferred embodiment of the material for motivating, tracking and confirming the independent study.

FIGS. 14A and 14B show examples of a preferred embodiment of the material for testing the skill, the unknown word, the unknown phrase and the mistake.

FIGS. 15A to 15E show examples of a preferred embodiment of the material for reporting and analyzing the progress.

### DETAILED DESCRIPTION

In the description, the foreign language for the leaner is English and the learner's mother tongue is Japanese.

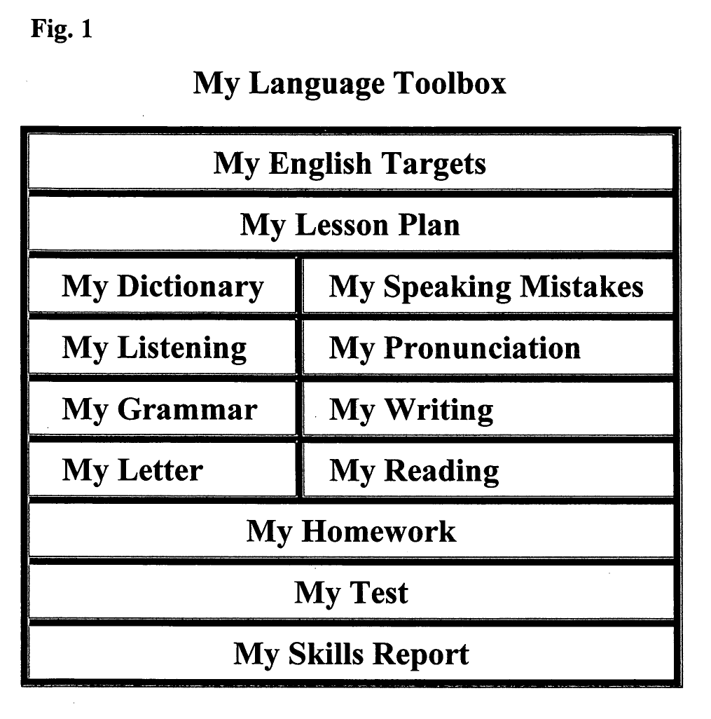

FIG. 1 shows an example of the contents of the tool in the present invention, My Language Toolbox. My Language Toolbox contains My English Targets as an example of the material to set the target of study; My Lesson Plan as an example of the material to make the plan of study; My Dictionary as an example of the learner-making dictionary; My Speaking Mistakes as an example of the material for speaking; My Listening as an example of the material for listening; My Pronunciation as an example of the material for pronunciation; My Grammar as an example of the material for grammar; My Writing as an example of the material for writing; My Letter as an example of the material for the letter; My Reading as an example of the material for reading; My Homework as an example of the material for motivating, tracking and confirming the independent study; My Test as an example of the material for testing the skill, the unknown word, the unknown phrase and the mistake; and My Skills Report as an example of the material for reporting and analyzing the progress.

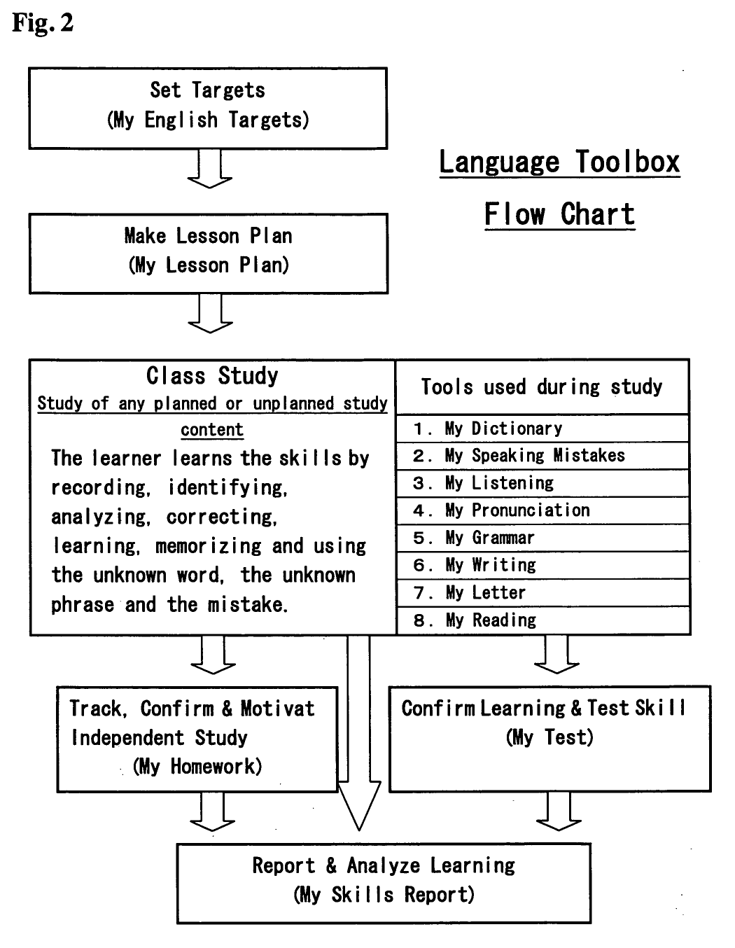

FIG. 2 shows an example of the method in the present invention, how to use My Language Toolbox. The learner first sets the target of study using My English Targets. Then the learner makes the plan of study using My Lesson Plan. In the class, the learner learns the skills by recording, identifying, analyzing, correcting, learning, memorizing and using the unknown word, the unknown phrase and the mistake; using at least one of My Dictionary, My Speaking Mistakes, My Listening, My Pronunciation, My Grammar, My Writing, My Letter and My Reading. After the class study, the learner motivates, tracks and confirms the independent study using My Homework. The learner also tests the skill, the unknown word, the unknown phrase and the mistake using My Test. Finally the learner submits and receives the report and analysis of the progress through My Skills Report.

The tools and methods of the present invention have remarkable advantages below.
The tools and methods achieve teaching based on and using the students' mistakes and what is new to the student. New words and new phrases particular to a student and students' mistakes are used and tracked in further studies. For example, what is new to the student appears in My Dictionary, My Speaking Mistakes, My Listening, My Pronunciation, My Grammar, My Writing, My Letter and My Reading. In addition, what is new to the student is reflected in My English Targets, My Lesson Plan, My Homework, My Test, My Skills Report.
The tools and methods achieve tracking mistakes in speaking, listening, and writing or for learning from a history of mistakes and a history of what is new to a student.
The tools and methods achieve connecting mistakes or what is new for a student in speaking, listening and writing to build a personal vocabulary.
The tools and methods achieve building new words and phrases that includes a translation and its original usage in a sentence and the correction and identification of the mistake or mistakes in the original sentence and confirmation of it memorization.
The tools and methods achieve application of the newly learned words or phrases in usage that provides a tracking record.
The tools and methods achieve record and tracking of identified mistakes made in speech and historical analysis is available.

These advantages of the present invention are more effective, when the unknown words, unknown phrases and the mistakes by the learner in at least one of materials appear on the other materials because the learner can practice the unknown words, unknown phrases and the mistakes in a repetition manner. It is preferable that the unknown words, unknown phrases and the mistakes made in at least one of the learner-making dictionary, the material for speaking, the material for listening, the material for pronunciation, the material for grammar, the material for writing, the material for the letter and the material for reading appear on at least one of the learner-making dictionary, the material for speaking, the material for listening, the material for pronunciation, the material for grammar, the material for writing, the material for letter and the material for reading. It is also preferable that the unknown words, unknown phrases and the mistakes made in at least one of the learner-making dictionary, the material for speaking, the material for listening, the material for pronunciation, the material for grammar, the material for writing, the material for the letter and the material for reading appear on at least one of the material to set the target of study; the material to make the plan of study; the material for motivating, tracking and confirming the independent study; the material for testing the skill, the unknown word, the unknown phrase and the mistake; and the material for reporting and analyzing the progress.

The present invention will be described in further detail by way of example.

### Material to Set Targets

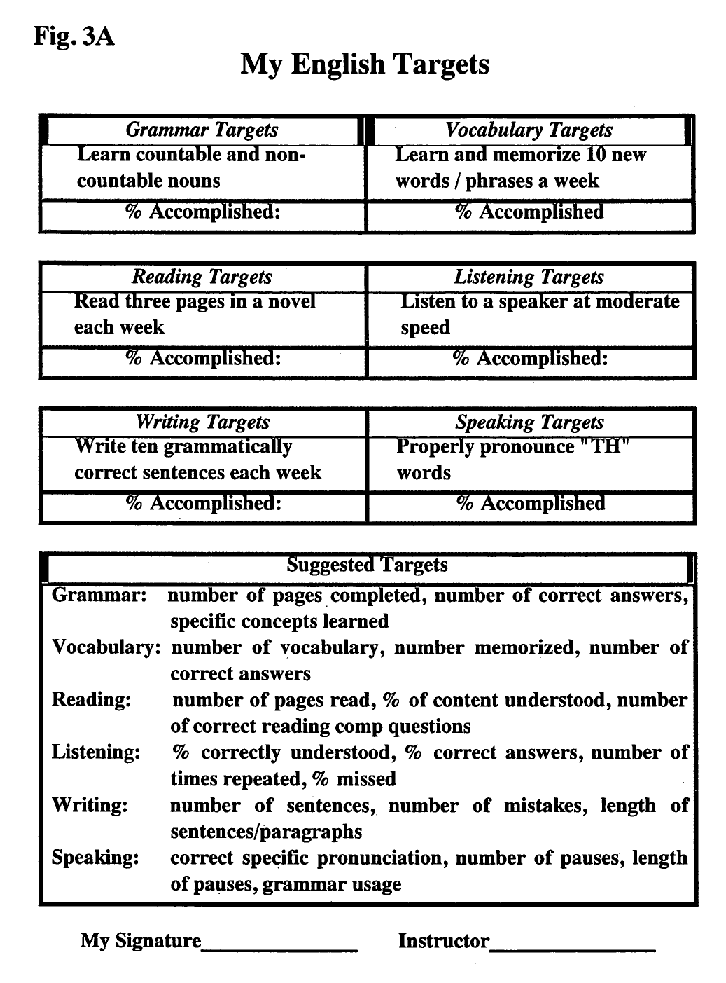

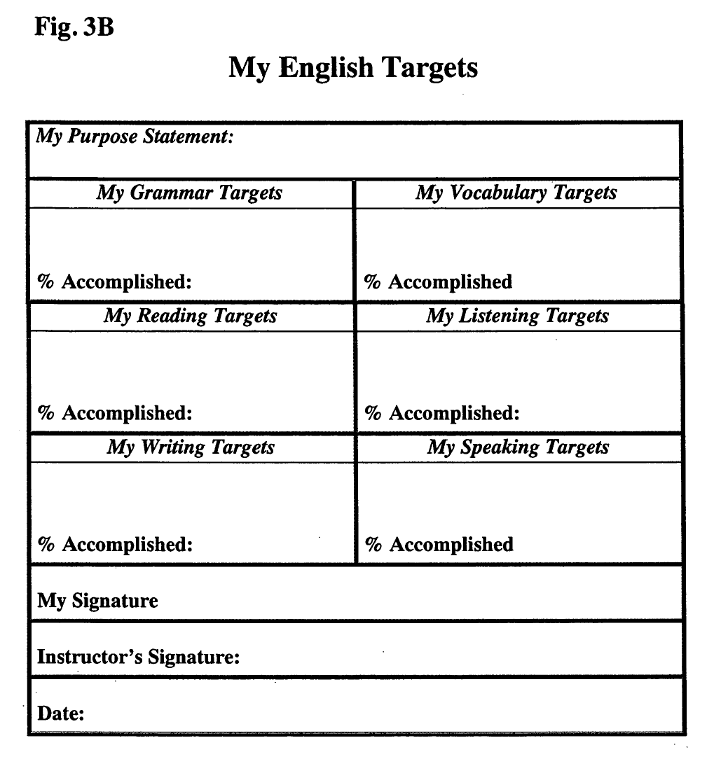

The tool of the present invention may contain a material to set a target. My English Targets of FIGS. 3A and 3B show preferred embodiments of the material.

As using My English Targets of FIG. 3B, the student inputs his or her purpose for studying the language in the “My Purpose” block. This aids in clarifying the motivation behind the students' desire to learn and study the language.

The instructor and student together or individually identify targets in each of the skill areas that are relevant to their study: vocabulary, grammar, listening, reading, speaking, and writing. The targets may be selected from a menu of suggested targets found in each skill area. The student or instructor may opt to create and input a unique target for any of the skill areas. In the event a target area is not relevant to a student then Not Applicable should be selected from that target's menu. As many targets as desired may be selected or input for each skill area. All targets selected must be completed at the end of the specified term. The default term is one month.

At the end of the term, the instructor, student, or software will judge and assign the percentage of completion on a scale spanning 0% to 100% for the targets in each skill area. When a percentage of completion is assigned in the “Percentage of Completion” block, the default color of the percentage will change to another color: for example from black to red.

After the term and the percentage for the targets in the skill areas have been assigned, both the instructor and the student sign the page in their respective signature blocks. The software, instructor or student also dates the page at the time of signing. After the completion of a term, the preceding process is repeated for the next term and new targets are selected. Targets from one term may be repeated in future terms if desired or not accomplished 100%.

Based on the targets, the lesson plan for study is created. In addition, the percentage of accomplishment of each skill areas is exported to My Skills Report.

By identifying the purpose for studying a language and specific targets relevant to each student a clear direction emerges in which studies can focus that are tailored specifically for the student. The targets also provide motivation for the student and establish goals for the student to accomplish greatly aid language development. A significant advantage is created in My English Targets in that not only are targets relevant to a student, but also they measured in relation to completion and reinforce language development by requiring the targets be accomplished within a set timeframe.

My English Targets additionally provides validation of the targets and accomplishments by have having both the student and instructor or software sign off on them each term.

The new material method provides a clear identification of purpose, language targets that are agreed upon by the student and instructor that are to be achieved within a set period of time. Based on the targets a lesson plan is created and at the end of the defined period of time achievement of the targets is assessed. This method also gives students confirmation of their accomplishment of their targets and reports on their skill, weaknesses, and enables current and future study recommendations relevant to areas of their language skills that need development.

### Material to Make a Plan

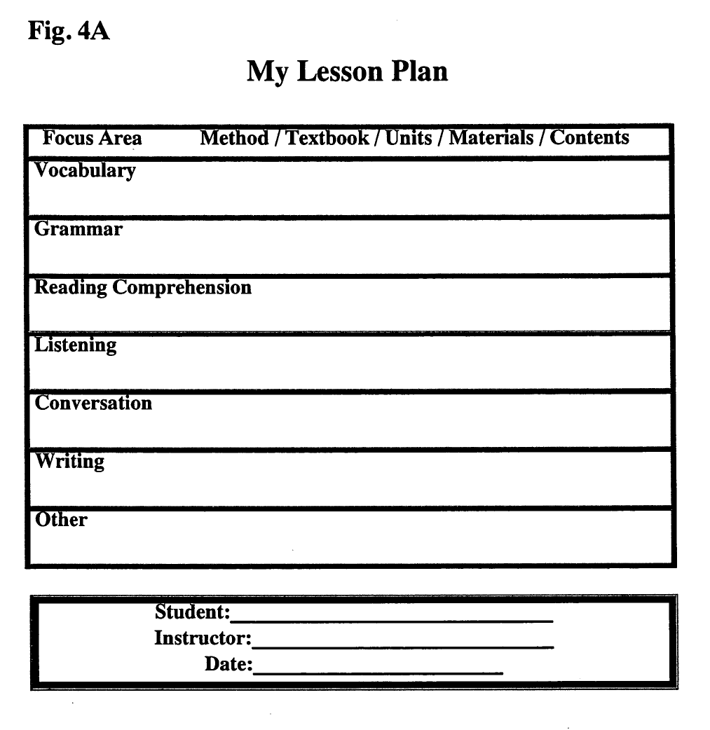

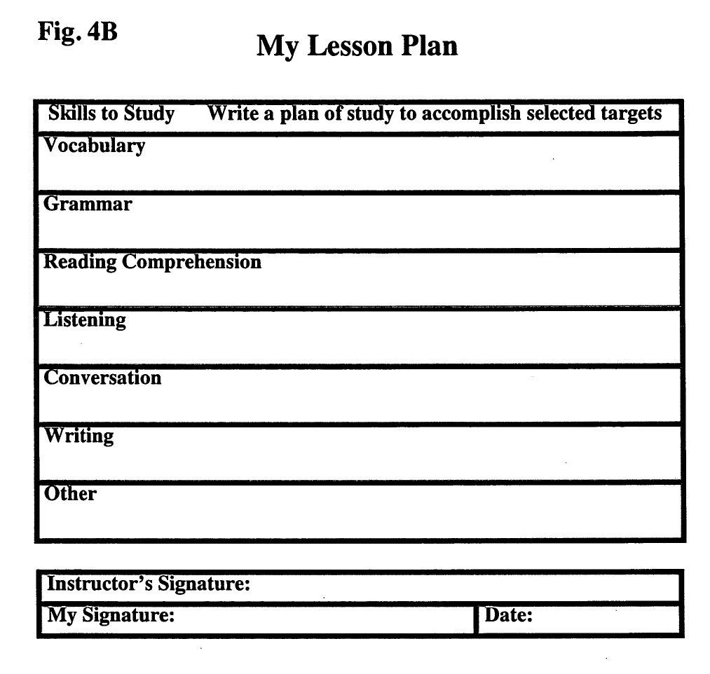

The tool of the present invention may contain a material to make a plan. My Lesson Plan of FIGS. 4A and 4B show preferred embodiments of the material.

As using My Lesson Plan of FIG. 4B, the instructor or software creates lesson plans to accomplish those targets, based on the skill areas and targets selected in My English Targets. Lesson plans are created for each skill area and targets chosen in My English Targets and input in the corresponding vocabulary, grammar, listening, reading, writing, and speaking blocks in My Lesson Plan. My Lesson Plan may also be created in skill areas not selected in My English Targets if desired, but at a minimum, must include lesson plans for all selected skill areas in My English Targets. Upon completion of My Lesson Plan both the student and instructor or software sign the lesson plan in the appropriate signature blocks to validate the plan.

By basing the lesson plan for the lesson on skill areas and targets personalized and pertinent to the student a tremendous advantage is created for both the student and instructor. The student is able to have lesson designed to help in accomplishing targets to build the skill areas identified in My English Targets as needed or desired.

### Learner-Making Dictionary

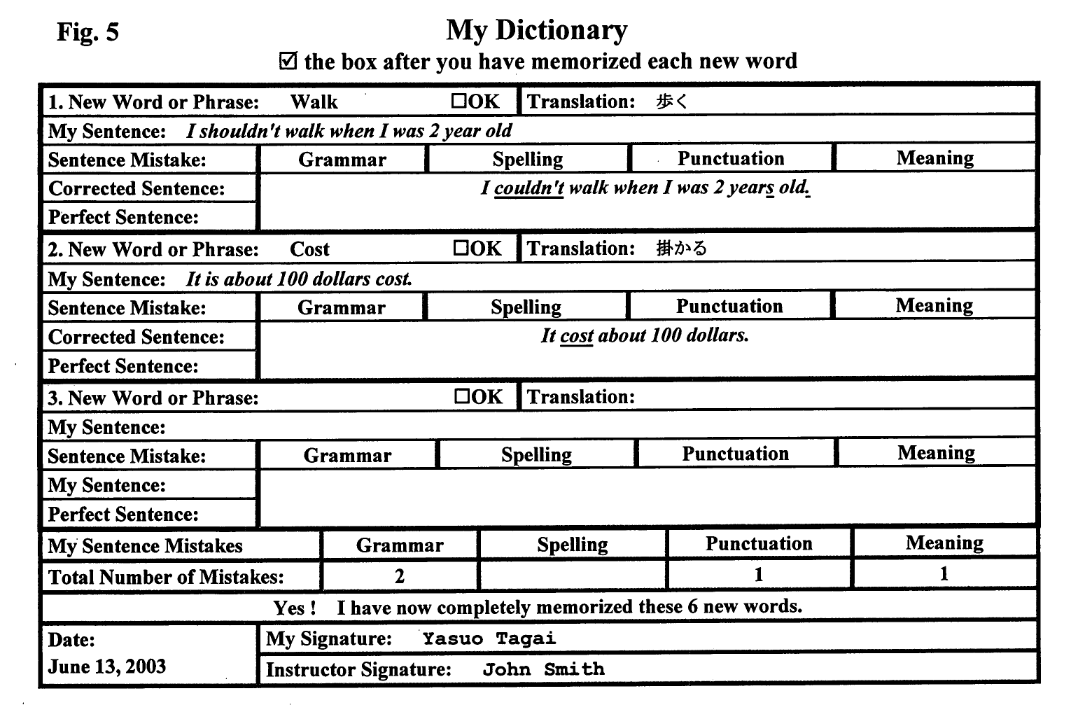

My Dictionary of FIG. 5 shows a preferred embodiment of a learner-making dictionary. The material is to expand words and phrase and to build a word usage and phrase usage. My Dictionary includes New Word or Phrase block as a new word, new phrase, mistaken word or mistaken phrase section; My Sentence block as a learner's sentence section; Sentence Mistake block as a mistake indication section; Corrected Sentence block as a corrected sentence section. In the case of new word and/or new phrase for the learner, My Dictionary also contains Translation block as a translation section.

As in FIG. 5 the learner learns first the word “Walk” and writes down or inputs the word in New Word or Phrase. He also writes down or inputs his mother tongue translation “ [symbol] ” in Translation. Then the learner makes his own sentence including the word in My Sentence and the sentence is corrected by an instructor and/or a software. The corrected sentence appears in Corrected Sentenced and what type of the mistake is highlighted in Sentence Mistake changing the color, for example black to red. My dictionary may include further My Sentence Mistake as a rating section.

By employing My Dictionary, provides the student with a tracking record of their own mistakes and the corrections and categorization of the mistakes, that is extremely useful for expanding words and phases as well as building word usage and phrase usage. By examining the historical record of the data the student and instructor are able to see patterns and categories of mistakes and understand what areas of the language need to be focused on in current or future studies. Words, phrase, and mistakes from My Dictionary can also be pulled out an applied in the other materials for additional development of their usage.

### Material for Speaking

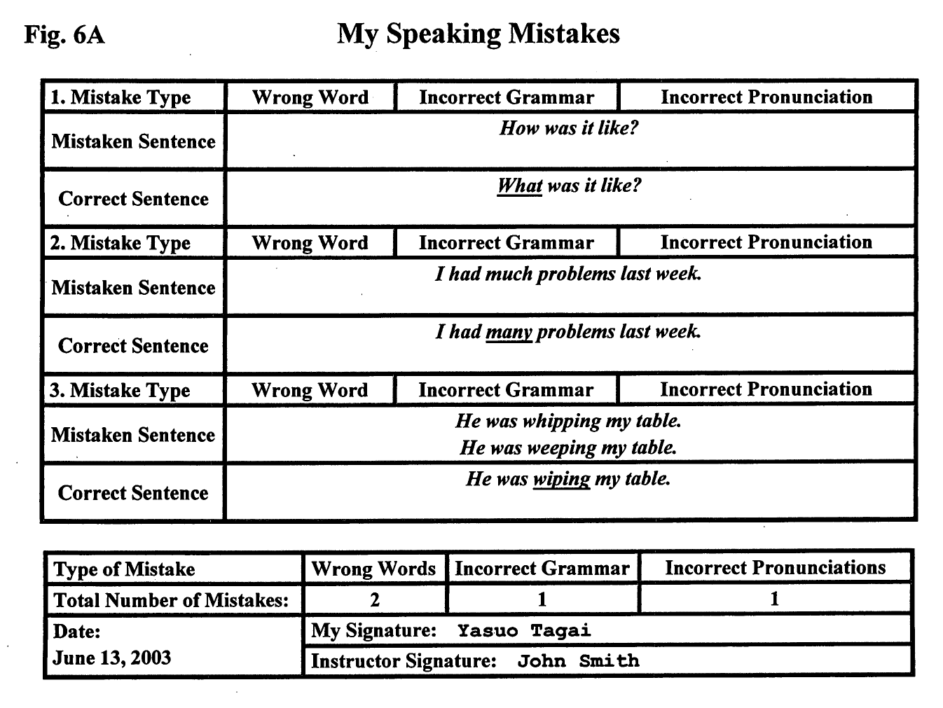

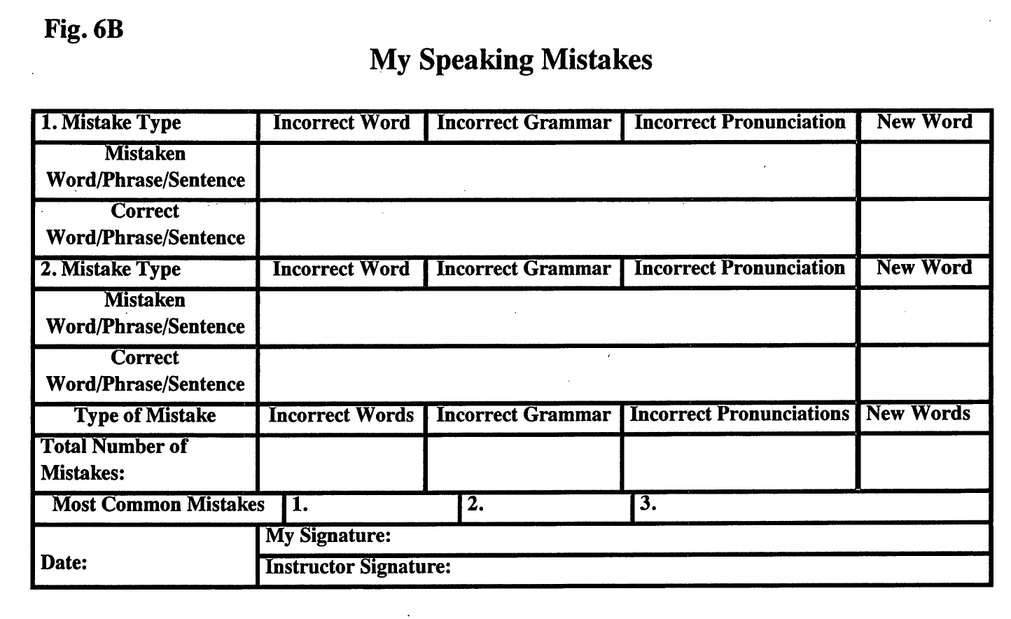

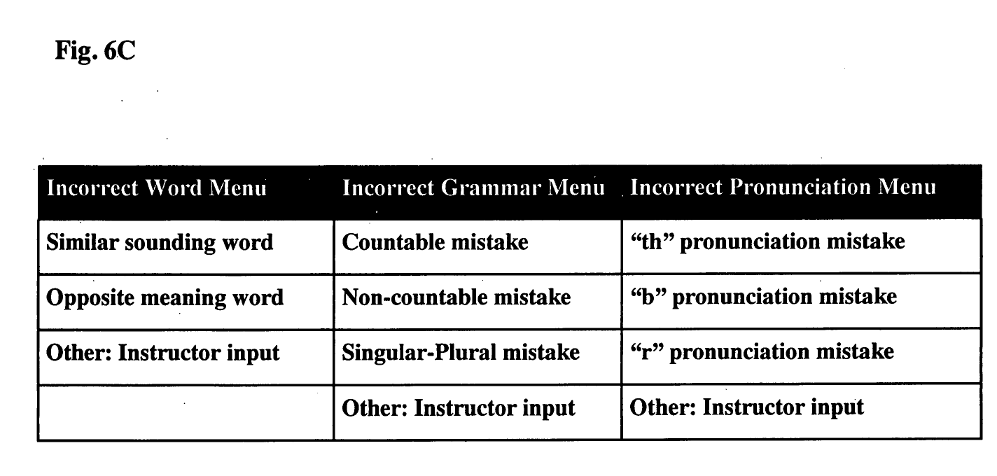

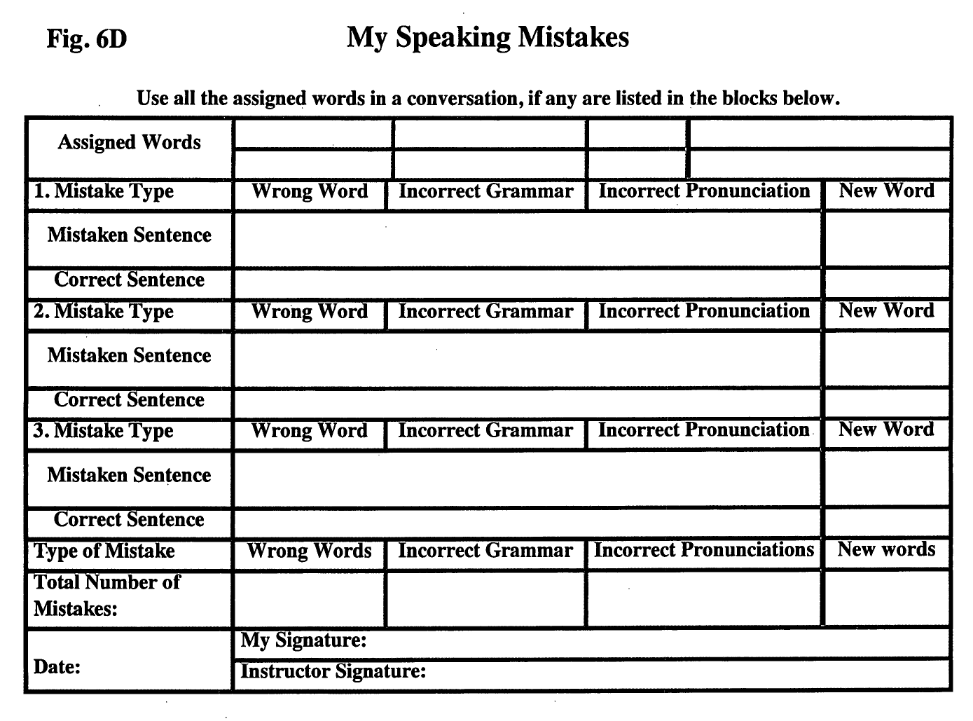

My Speaking Mistakes of FIGS. 6A to 6D show preferred embodiments of the material for speaking. My Speaking Mistakes includes Mistaken Sentence block or Mistaken Word/Phrase/Sentence block as a mistaken section; Corrected Sentence block or Correct Word/Phrase/Sentence block as a corrected sentence section. My Speaking Mistakes may also include Type of Mistake block and Total Number of Mistakes block as a rating section.

As shown FIG. 6B, there are two Mistaken Word/Phrase/Sentence blocks on a single piece in the material, which is displayed on a monitor or on printed-paper, and an infinite number of pieces. However, the number of Mistaken Word/Phrase/Sentence blocks on a single piece may be increased or decreased as desired. For example ten Mistaken Word/Phrase/Sentence blocks can be defined as a single piece.

When the instructor or software categorizes the type mistake by selecting the appropriate Mistake Type category in the software; Incorrect Word, Incorrect Grammar, or Incorrect Pronunciation, a menu of choices will drop down to allow a more precise description of the type of mistake made, or if none of the menu items suitably match the mistake, then the instructor may input their own description of the mistake made or choose the default mistake type Incorrect Word, Incorrect Grammar, and Incorrect Pronunciation. Examples of the software menus are shown in FIG. 6C.

Using My Speaking Mistakes the student speaks, the instructor or software listens and identifies language mistakes. The instructor or software then inputs the spoken language mistake in the Mistaken Word/Phrase/Sentence block in My Speaking Mistakes. The instructor or software then corrects the mistaken word/phrase/sentence and inputs the corrected word/phrase/sentence in the Correct Word/Phrase/Sentence block in My Speaking Mistakes.

The instructor or software then underlines the mistake or mistakes in the student's word, phrase, or sentence and underlines the correction in the corrected word, phrase, or sentence. In Mistake Type block, the instructor or software then categorizes the type mistake by selecting and highlighting the appropriate Mistake Type category; Wrong or Incorrect Word, Incorrect Grammar, or Incorrect Pronunciation located above the Mistaken Word/Phrase/Sentence block in the materials. More than one Mistake Type may be selected. When a Mistake Type category is selected, the default color of the category will change to another color: for example from black to red.

Often, a student speaking will say one word but mean another, in this case the student does not know the meaning of word actually used. Therefore, in the Mistaken-Word/Phrase/Sentence made by student if there is a word or phrase that was used but not understood by the student, then that unknown word or phrase is input by the software or instructor in the New Word block located on the farthest right column of the material in FIG. 6B.

At the bottom of each material, the total number of each type of mistake and the three most common type of mistakes made by the student are tracked and displayed for viewing by the instructor and student. As a default, the results are displayed on each material, but the instructor or student may choose not to have the results display present on each material, even if not displayed on each material the results are always stored and may be displayed in the other material.

Upon completion of one of speaking mistakes in the material, both the student and the instructor sign the material and simultaneously the software, instructor, or student dates the material.

Mistakes and the new words identified in the My Speaking Mistakes are exported by the software or by the instructor to the other materials such as My Dictionary, My Writing and My Pronunciation for learning the correct use of those mistakes and words. The record of all the mistakes is exported to the reporting material such as My Skills Report for viewing an analysis of the mistakes and identification of areas that need yet to be learned.

The unknown word, the unknown phrase and the mistake of My Speaking Mistakes may be also recorded on My Dictionary. In addition, the unknown word, the unknown phrase and the mistake of My Speaking Mistakes may be also recorded on the other materials below.

My Speaking Mistakes enables the recording, categorizing, correction, and analysis of spoken mistakes and provides a record of mistakes made over a period of time that allows for additional analysis of the areas the student needs to study based on the record of mistakes. The material also pulls out specific words, phrases, and mistakes and transfers them to other materials for additional learning and memorization. The material provides the student with a record of their own speaking mistakes and the corrections and categorization of the mistakes. By examining the historical record of the data the student and instructor are able to see patterns and categories of mistakes and understand what areas of the language need to be focused on in current or future studies.

With My Speaking Mistakes, students gain tremendous advantage by learning specific knowledge of how they are using the language incorrectly in conversation and learning the correct usage of their mistakes.

My Speaking Mistakes is extraordinary in providing students and instructors a tool and method to identify the students' specific speaking mistakes, record and correct the mistakes and enable the identification and learning of unknown words.

Students and instructors for the first time have the ability to clearly see the spoken mistakes and corrections and see a history of mistakes made over time that enables invaluable identification of language areas and elements the student has not yet mastered. My Speaking Mistakes further allows the student to focus on and learn those specific language areas and elements still not understood.

Indeed extraordinary, the My Speaking Mistakes and the other materials in the present invention tool create highly personalized learning based on the student's own mistakes. The tool takes the mistakes and words unknown to the student and turns them into learning exercises by providing the student additional study of the mistakes and unknown words in My Dictionary, My Writing, and My Pronunciation facilitating development of their language skill.

In addition, My Speaking Mistakes with its historical tracking of the mistakes and corrections is able to identify mistakes that are repeated over time, which indicates elements of the language that the student still needs to learn. The analysis and display of the three most common mistakes made also provide students with immediate feedback on areas or elements of the language they need to learn in order to improve their language skills.

### Material for Listening

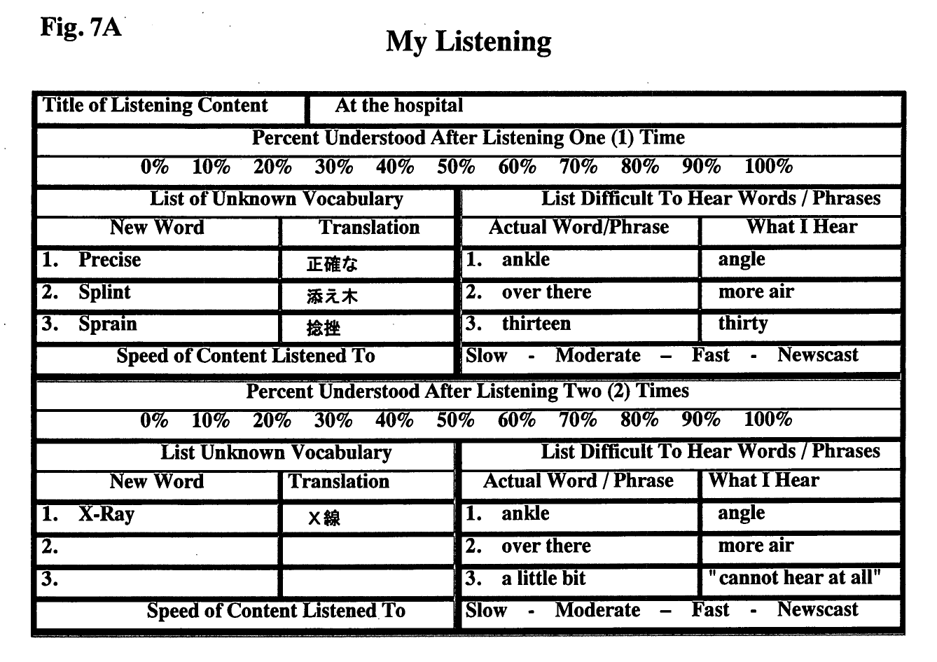

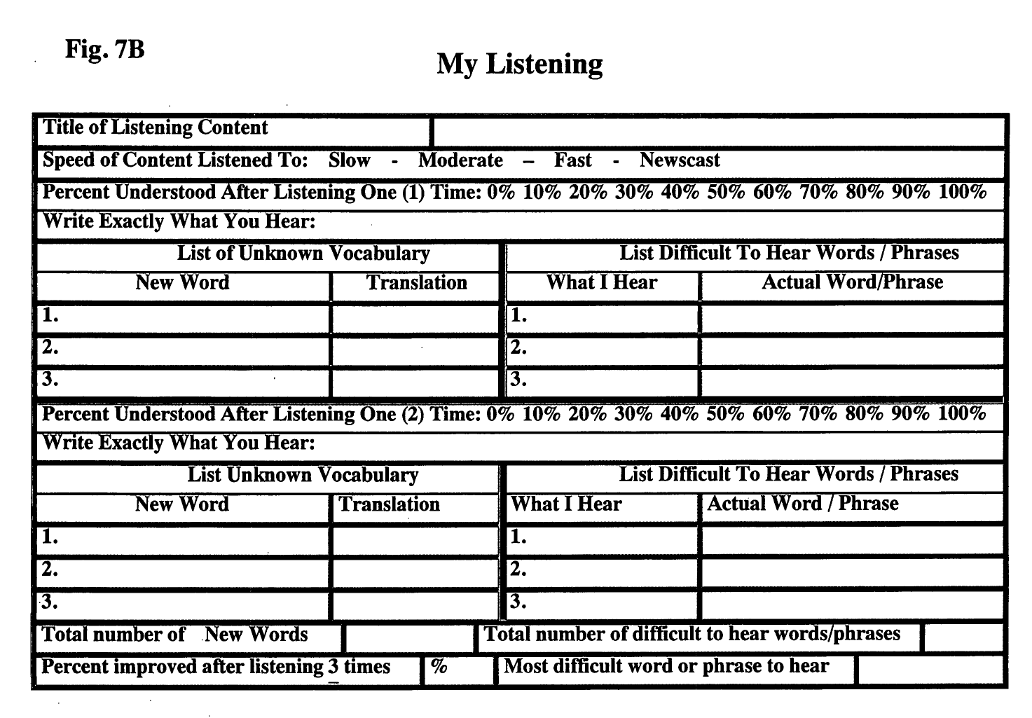

My Listening of FIGS. 7A and 7B show preferred embodiments of a material for listening. My Listening includes one or several sets of assessments of listening comprehension. Each assessment contains List of Unknown Vocabulary block as a new word or new phrase section; and List Difficult to Hear Words/Phases block as a mistaken word or mistaken phrase section. My Listening may also include Write Exactly What You Hear block as well as Percent Understood after Listening block and Speed of Content Listened to block as a rating section.

As in FIG. 7B, the instructor or student inputs or the software displays the title of the content that will be listened to. The instructor or the software then reads out loud or plays a recording of the content for the student to hear. The delivery speed of the content listened to is then highlighted; Slow, Moderate, Fast, or Newscast in the “Speed of Content Listened To” block of the material. When any item is highlighted in the material, the default color of the item will change to another color: for example from black to red.

After the hearing the content one time the student either repeats or writes word-for-word the content heard in the first “Write exactly What You Heard” block in the piece. If repeating the content using the software, the student would input the responses in a microphone linked to the software via an electronic device. The instructor or software then ascertains what the student heard and understood by comparing the response of the student to the actual content.

Based on the percent of what the student correctly repeats when compared to the actual content, the software displays or the instructor highlights the percent of the content understood in the “Percent Understood After Listening One (1) Time” block. The software or the instructor identifies words or phrases in the content listened to that are unknown to the student and inputs them in the unknown word block. Then the software, instructor, or student translates the unknown word or phrase and inputs the translation in the Translation block in the piece. The software or the instructor then identifies content that was heard incorrectly and inputs those words, phrases, and or sentences in the “What I Heard” block. Words and phrases that could simply not be heard by the student at all are listed as “Can't hear at all” in the “What I Heard” block.

At this point there are two options to choose from depending on the skill level the student. Option one, the instructor inputs or the software displays the actual content of what was heard in the “Actual Content” block opposite the corresponding “What I Head” block and displays to the student. Option two, the “Actual Content” is not displayed until after completion of the listening training.

The same content is then played again for a second time and preceding steps repeated. The content may be repeated as many times thereafter as desired with the preceding steps repeated.

Upon finishing listening to the content as many times desired, all the actual content is input or displayed in the “Actual Content” block. The student and instructor may then view the total number of unknown words and phrases, total number of difficult words to hear, most difficult word to hear, and the percent improved after listening to content when comparing the fist time listening to the last time listening are display at the bottom of the piece.

As a default, the above results are displayed on each piece of the tool, but the instructor or student may choose not to have the results display present on each piece of the tool, even if not displayed on each piece the results are always stored and displayed in the results tool.

The unknown words and translations identified in the My Listening are exported by the software or by the instructor to the other materials such as My Dictionary, My Writing, while the correct words and phrases in “Actual content” corresponding to mistakes in “What I Hear” are exported to the other materials such as My Pronunciation for learning the correct use of those mistakes and words. The record of all the mistakes is exported to the recording materials such as My Skills Report tool for viewing an analysis of the mistakes and identification of areas that need yet to be learned.

The unknown word, the unknown phrase and the mistake of My Listening may be also recorded on My Dictionary and/or My Speaking Mistakes. In addition, the unknown word, the unknown phrase and the mistake of My Listening may be also recorded on the material.

My Listening facilitates identification of the students' obstacles to hearing a language. Hearing problems are categorized into new words and phrases unknown to the student or words and phrases that cannot be heard and records and provides a historical record of those elements.

One advantage of this material for listening is that it facilitates the identification of problems in hearing a language and why it cannot be heard. With this material the student can learn what elements of the spoken language they cannot hear or understand and why they cannot hear or understand it.

The material also identifies and tracks the percentage a student is able to understand and speed of the language that they are hearing. The material also pulls out specific words, phrases, and mistakes and transfers them to other materials for additional learning and memorization. The material provides the student with a record of their own listening mistakes and the corrections and categorization of the mistakes. By examining the historical record of the data the student is able to see patterns and categories of mistakes and understand what areas of the language need to be focused on in current or future studies.

My listening, for the first time, provides the students and the instructors with a superb advantage in grasping the precise weakness of the students' listening capabilities allowing identification of not only what the student cannot hear, but also why the student cannot hear it and helps the student correct those weaknesses.

This is achieved by arming the student with the precise knowledge of words and phrases they did not know when they heard them and teaches them those words which in turn enables understanding of the content listened to. At the same time the student expands their vocabulary by learning from their mistakes the unknown words and phrases.

Precise understanding of weaknesses in listening skills is also achieved by clear identification of mistakes in listening through reproduction of exactly what they heard and comparing it to what was actually said. Students can see what they thought they heard and realize the difference between what was actually said. With My Listening, students accomplish learning from their own mistakes to hear specific sounds, words, phrases and language patterns.

By tracking the history of mistakes, patterns of weakness in listening to specific sounds, words, and phrase are clearly identified enabling awareness and focused correction of the mistakes. The tracking of mistakes also validates learning of the mistakes in so far as if the student has truly learned from the mistakes they should not be reappear in future records of mistakes after learning the correction.

My Listening provides a significant advantage in developing listening skills with a historical record of unknown words and phrases and a historical record of difficult to hear sounds, words, and phrases specific to a student.

Generally, there are two reasons why a student has problems listening to a foreign language: there are unknown words in the content or the student is unable to distinguish and identify the words spoken even though they know them. Words or phrases that students are unable to distinguish are often words and content that they know, but just cannot hear.

By examining these historical records of mistakes and unknown words, students and instructors can see patterns of mistakes relevant to the student and focus their studies on learning those elements of the language that they do not yet understand. This highly personalized information about their precise weaknesses in listening ability is of significant value to the language learner and greatly improves development of listening skills.

### Material for Pronunciation

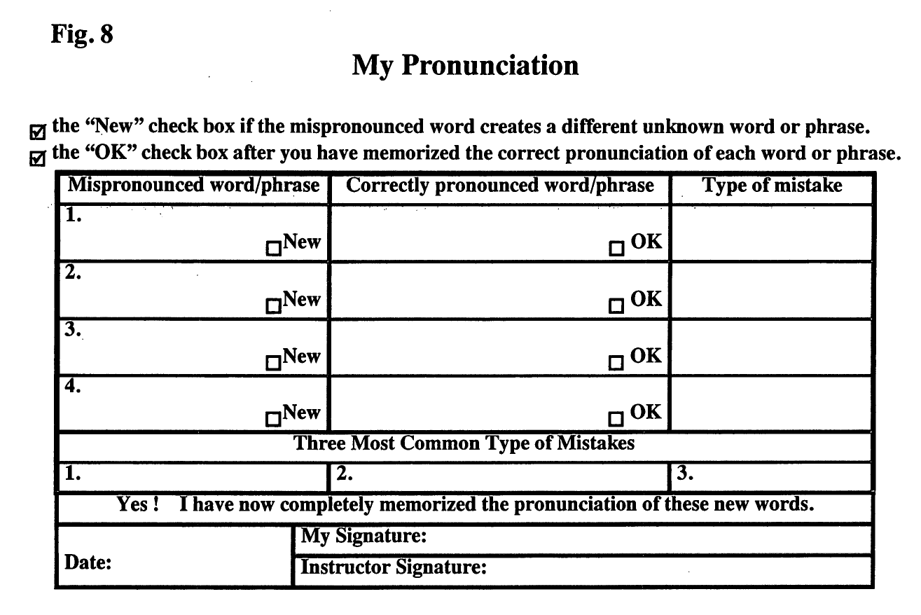

My Pronunciation of FIG. 8 shows a preferred embodiment of a material for pronunciation. As using My Pronunciation, the instructor or software use this material when identifying pronunciation mistakes and record, correct and categorize the mistakes in the appropriate blocks in the material. In the event that a word is unknown to the student, it is marked as “New” and a copy transferred to the other materials such as My Dictionary, My Writing, My Letter, and My Grammar for additional study. After the student learns and memorizes the correct pronunciation of a word or phrase, the check box is marked next to it. When the pronunciations of all words in the piece have been correctly memorized, both the student and the instructor or software sign it. By tracking the history of pronunciation mistakes specific mistakes and specific patterns of pronunciation weakness can be identified. Using this information focused study on correcting those pronunciation problems can be done.

### Material for Grammar

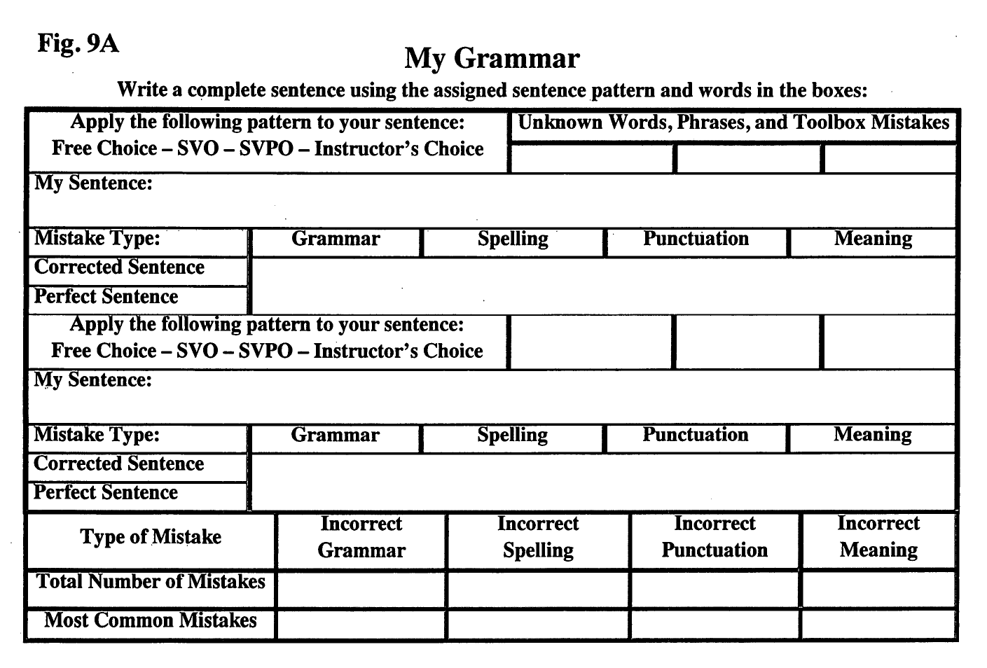

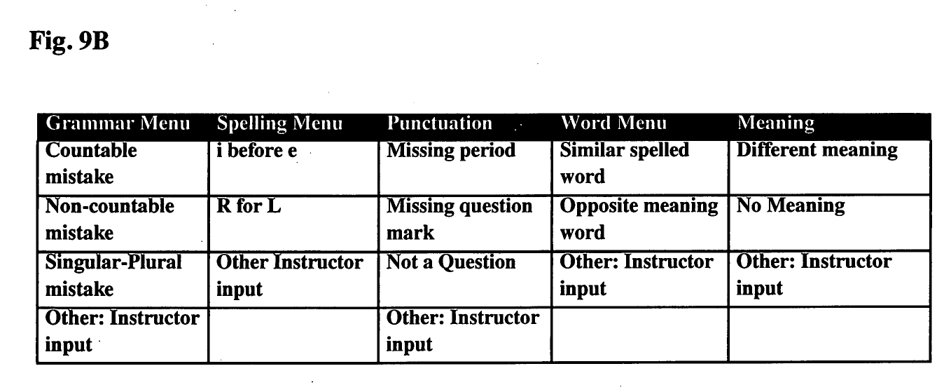

My Grammar of FIGS. 9A and 9B shows a preferred embodiment of a material for Grammar. As using My Grammar of FIG. 9A, the instructor or software assigns a grammatical sentence pattern from a selectable menu of sentence patterns, such as Subject-Verb-Object (SVO), to be applied in a sentence created by the student. The instructor or software may also assign Free Choice allowing the student to use any grammatical pattern they choose or in the case a pattern is not on the menu an instructor may input their own pattern. One or more unknown word, phrase or mistake from My Dictionary, My Writing, and My Pronunciation is displayed in the Unknown Words, Phrases, and Toolbox Mistakes blocks. The instructor may also input their original words or phrases in the Unknown Words, Phrases, and Toolbox Mistakes blocks.

Using the words, phrases or mistakes in the Unknown Words, Phrases, and Toolbox Mistakes blocks and the assigned grammatical sentence pattern the student must create and input an original sentence in My Sentence block.

The software or instructor analyzes the student created sentence and inputs a corrected version of the sentence if it contains one or more mistakes. The instructor or software then underlines the mistake or mistakes in the student's word, phrase, or sentence and underlines the correction in the corrected word, phrase, or sentence. The instructor or software then categorizes the type mistake by selecting the appropriate Mistake Type category; grammar, spelling, punctuation, word, or meaning. More than one Mistake Type may be selected for each corrected sentence. When a Mistake Type category is selected, the default color of the category will change to another color: for example from black to red.

When the instructor or software categorizes the type mistake by selecting the appropriate Mistake Type category in the software; grammar, spelling, punctuation, word, or meaning, a menu of choices will drop down to allow a more precise description of the type of mistake made, or if none of the menu items suitably match the mistake, then the instructor may input their own description of the mistake made or choose the default mistake type. Examples of the software menus are shown in FIG. 9B.

At the bottom of each piece in the tool, the total number of each type of mistake and the three most common type of mistakes made by the student are tracked and displayed for viewing by the instructor and student. As a default, the results are displayed on each page of the tool, but the instructor or student may choose not to have the results display present on each page of the tool, even if not displayed on each page the results are always stored and displayed in the results tool.

Mistakes in My Grammar are exported to My Dictionary, My Writing, and My Pronunciation for additional study.

### Material for Writing

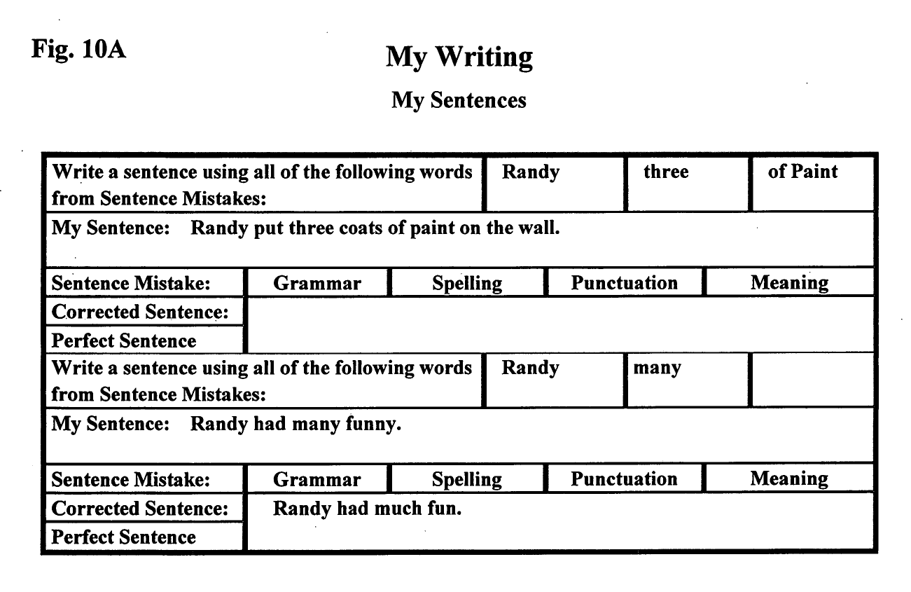

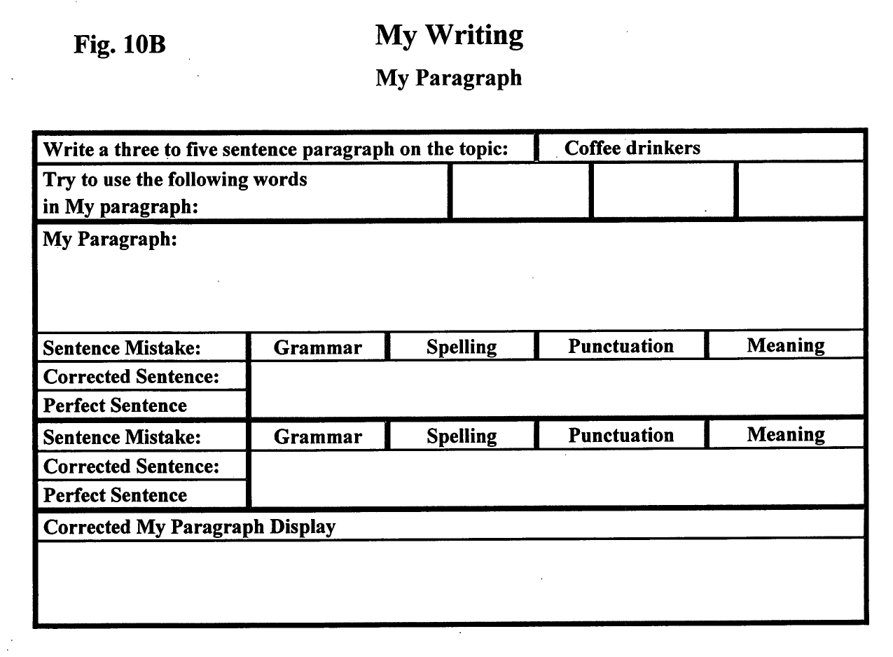

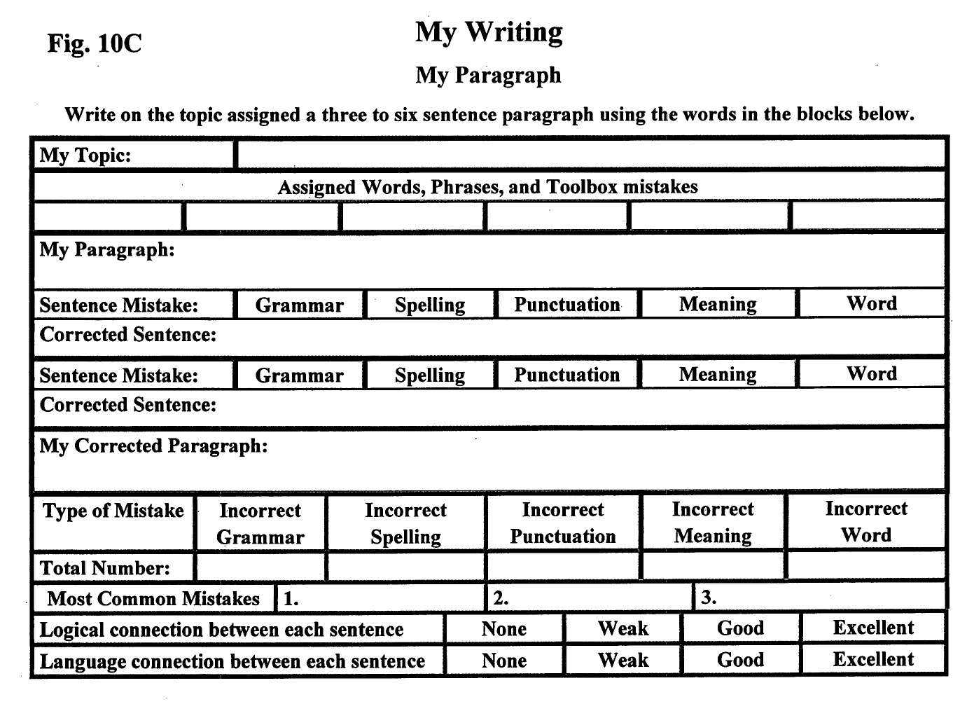

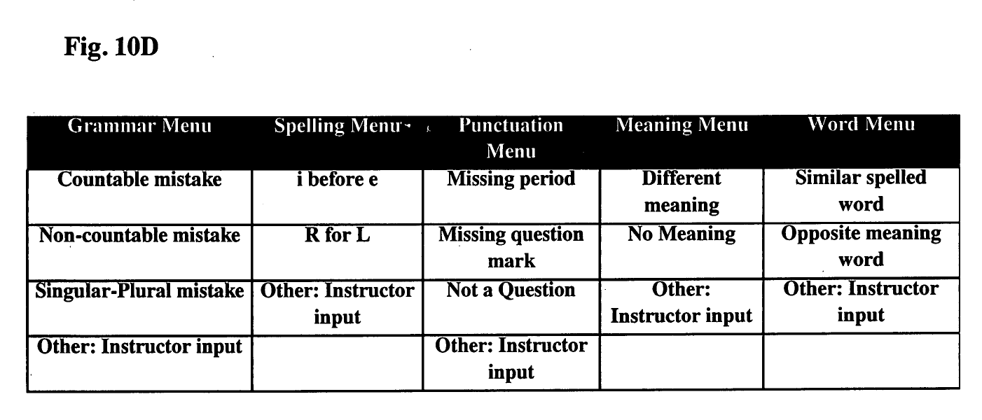

My Writing of FIG. 10A shows a preferred embodiment of a material for writing where the learner writes his own sentence. My Writing contains My Sentence block as a leamer's writing section; and Corrected Sentence block as a corrected sentence section. Using words and phrases appearing in Write a Sentence Using All of Following Words block, the learner writes down or inputs his own sentence. Words and phrases appearing in Write a Sentence Using All of Following Words block may be selected from the recordation of My Dictionary, My Speaking Mistakes and/or My Listening. These words and phrases may be also provided by the instructor.

My Writing of FIG. 10B shows a preferred embodiment of a material for writing where the learner writes his own paragraph. My Writing contains My Paragraph block as a leamer's writing section; and Corrected Sentence block as a corrected sentence section. Using words and phrases appearing in Try to Use The Following Words block, the learner writes down or inputs his own paragraph. Words and phrases appearing in Try to Use The Following Words block may be selected from the recordation of My Dictionary, My Speaking Mistakes and/or My Listening. These words and phrases may be also provided by the instructor.

Using My Writing of FIG. 10C, the instructor or software assigns a topic and inputs it in the My Topic block. One or more unknown word, phrase or mistake from My Dictionary, My Speaking Mistakes, My Listening, My Writing, and My Pronunciation is displayed in the Unknown Words, Phrases, and Toolbox Mistakes blocks. The instructor may also input their original words or phrases in the Unknown Words, Phrases, and Toolbox Mistakes blocks.

Using the words, phrases or mistakes in the Unknown Words, Phrases, and Toolbox Mistakes blocks must create and input three to six original sentences to form a paragraph in My Paragraph block.

The software or instructor analyzes the student created sentences and inputs a corrected version of the sentence if it contains one or more mistakes. The instructor or software then underlines the mistake or mistakes in the student's word, phrase, or sentence and underlines the correction in the Corrected Word, Phrase, or Sentence block. The instructor or software then categorizes the type mistake by selecting the appropriate Mistake Type category; grammar, spelling, punctuation, word, or meaning. More than one Mistake Type may be selected for each corrected sentence. When a Mistake Type category is selected, the default color of the category will change to another color: for example from black to red.

When the instructor or software categorizes the type mistake by selecting the appropriate Mistake Type category in the software; grammar, spelling, punctuation, word, or meaning, a menu of choices will drop down to allow a more precise description of the type of mistake made, or if none of the menu items suitably match the mistake, then the instructor may input their own description of the mistake made or choose the default mistake type. Examples of the software menus are shown in FIG. 10D.

Mistakes made in My Writing are exported to the other materials such as My Dictionary, My Grammar, and My Pronunciation. After sentence mistakes are corrected, the entire paragraph is displayed in its corrected form in the My Corrected Paragraph block.

At the bottom of each piece in the tool, the total number of each type of mistake and the three most common type of mistakes made by the student are tracked and displayed for viewing by the instructor and student. The logical and the language connections between each sentence are ranked and displayed by the software or instructor.

As a default, the results are displayed on each piece of the tool, but the instructor or student may choose not to have the results display present on each piece of the tool, even if not displayed on each piece the results are always stored and displayed in the results tool.

### Material for a Letter

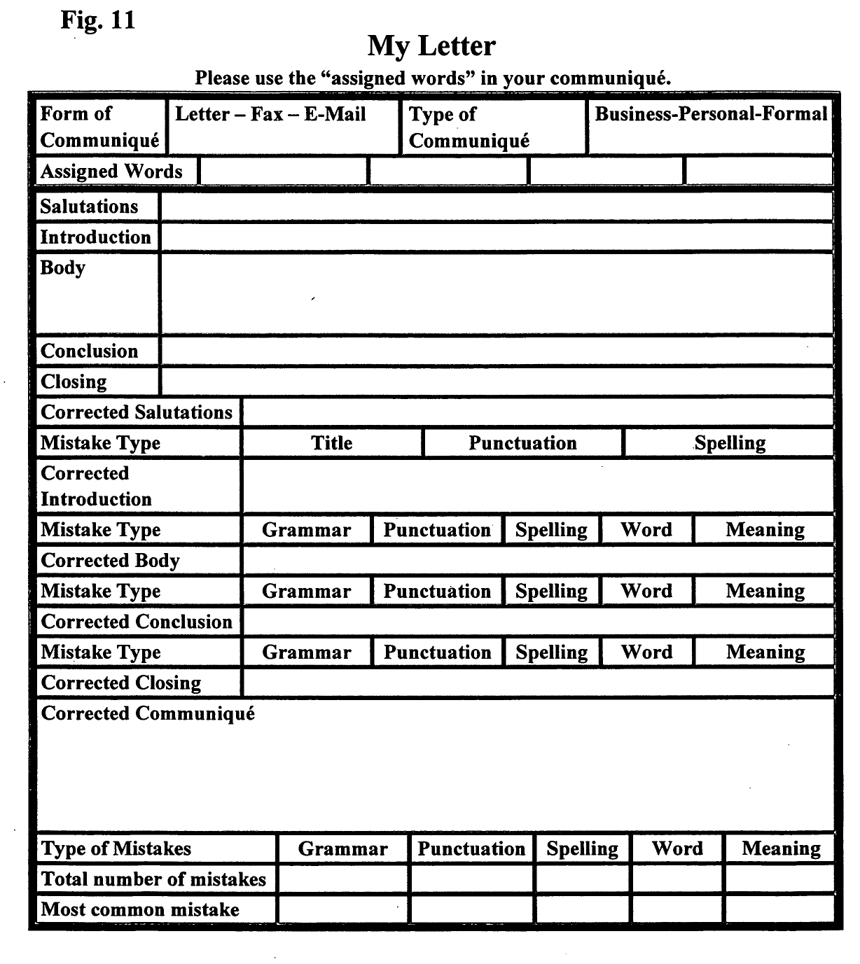

My Letter of FIG. 11 shows a preferred embodiment of a material for a letter. As using My Letter, the student selects the type of communique to write and then input the contents. Depending on the type of communique selected, the proper outline of the parts of the document will be used or displayed. For example, in a facsimile, the salutation would not be displayed, as it is not part of an official facsimile. Mistakes from the other materials, or instructor selected words or phrases may be input in the Assigned Words block. The student then incorporates the assigned words in the contents they are writing. After inputting the contents, the instructor or software will correct the mistakes in the contents and categorize them in the appropriate blocks in the material. The complete corrected contents will be displayed in a display block. A summary of the mistakes made will also be displayed. This material allows learning and application of mistakes made in other materials and builds the students' letter writing skills. On the other hand, mistakes made in this material can be exported to My Dictionary, My Grammar, My Writing, and My Pronunciation. The summary of mistakes will be exported to My Skills Report.

### Material for Reading

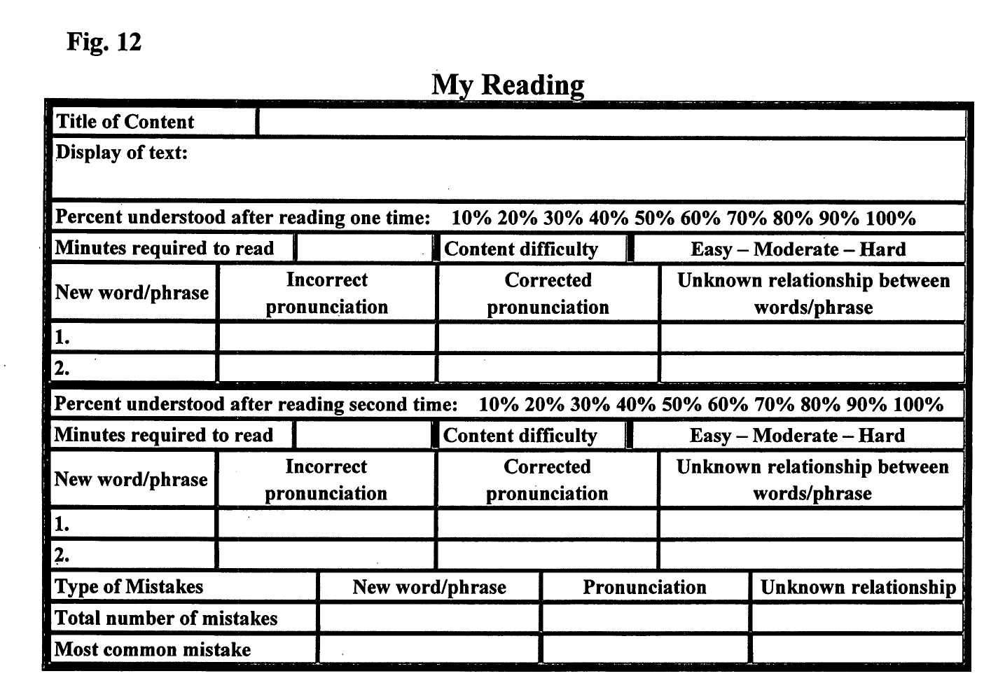

My Reading of FIG. 12 shows a preferred embodiment of a material for reading. As using My Reading, the student reads the material for reading out loud to the instructor or software. As the student reads the instructor or software identify mistakes and categorize them in the material. The length of time required to complete the reading and degree of difficulty are indicated and the instructor or software inputs the degree to which the student understood the contents of the reading. The reading is then read a second time and following the same procedures as the fist time reading through the contents. The reading may be repeated as many times as desired. Pronunciation problems are transferred to the other materials such as My Pronunciation and unknown words and phrases are transferred to the other materials such as My Dictionary, My Grammar, and My Writing. This material provides the advantage of identifying mistakes in the reading and then allowing for those mistakes to be corrected and learned.

### Material for Motivating, Tracking and Confirming an Independent Study

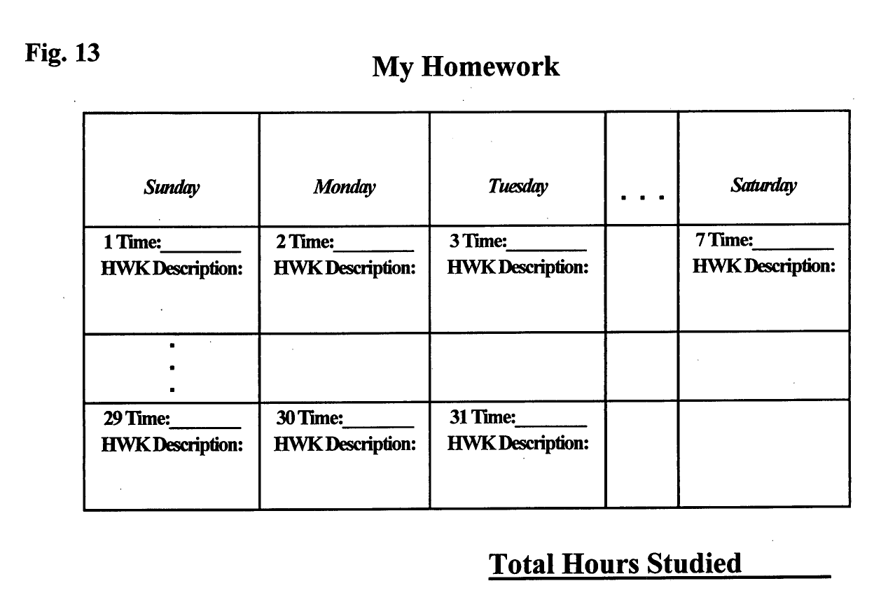

My Homework of FIG. 13 shows a preferred embodiment of a material for motivating, tracking and confirming an independent study. The material is to organize a self-lesson out of a class.

The student inputs on a daily basis, in the corresponding block with the day of the month identified, the total amount of time spent studying homework and a brief description of the homework. At the end of the month the total number of hours studied are input or displayed in the Total Hours Studied Block. The student then signs the My Homework in the “My Signature” block at the end of every month studying a foreign language.

My Homework achieves a significant advantage for student and instructors by creating a historical record of how much time was spent studying outside the classroom and what was studied. Students and instructors gain a clear picture of what they have done in terms of studying outside the classroom. That information serves as motivation to the student and provides the instructor with the information regarding insufficient study and when the student is in the need of additional motivation or support with the homework.

### Material for Testing The Skill, the Unknown Word, the Unknown Phrase and the Mistake

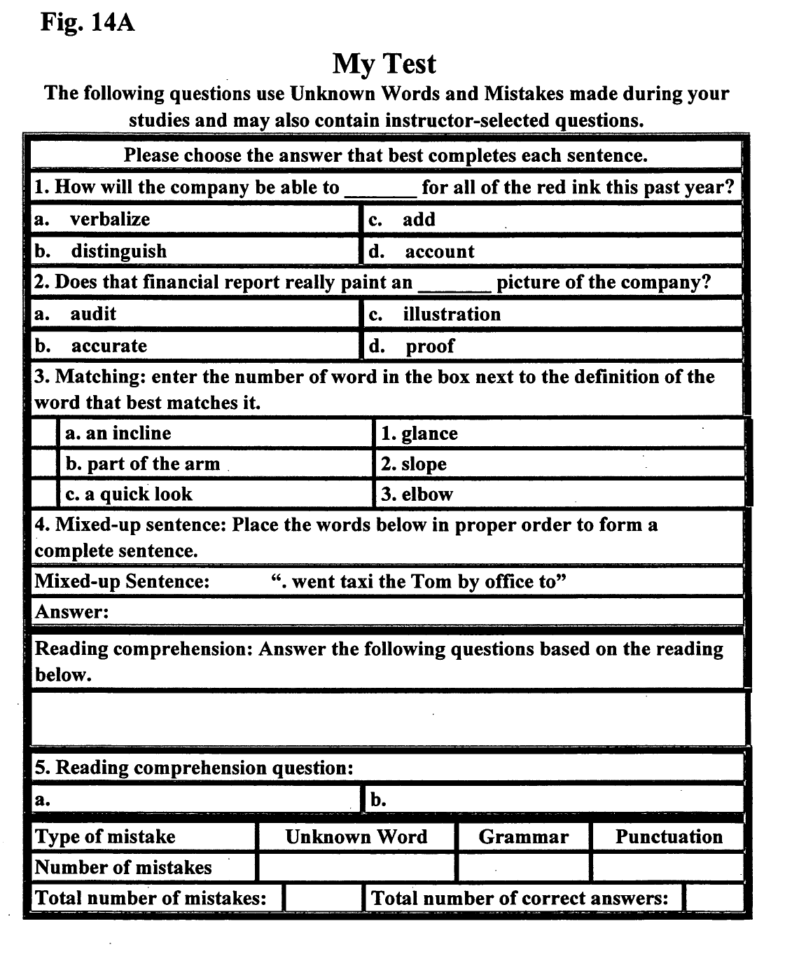

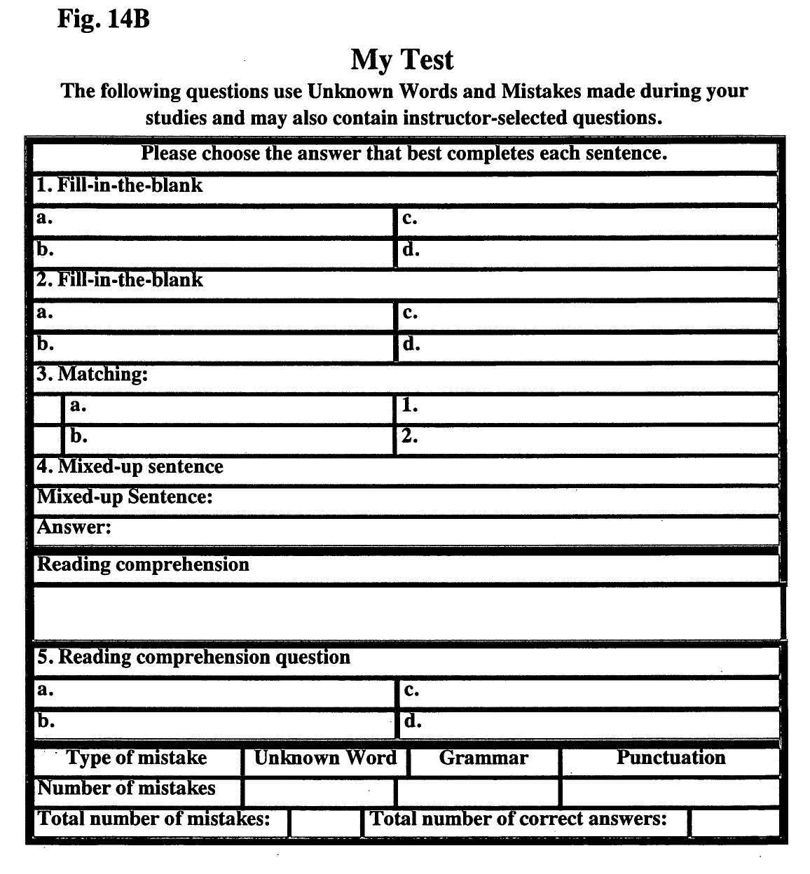

My Test of FIGS. 14A and 14B show preferred embodiments of the material for testing the skill, the unknown word, the unknown phrase and the mistake.

The instructor or software create a test comprising mistakes and unknown words and phrases drawn from the other tools in My Language Toolbox or may provide independent test materials to the student. The test may also contain a combination of instructor selected test questions and test questions created using the mistakes and unknown words and phrases. Any type of test question may be used in My Test, for example, fill-in-the-blank, matching, reading comprehension, and other types of test questions. When the test is corrected, the incorrect answers and the corresponding correct answer may be transferred to other tools for learning of the mistakes and unknown words and phrases. The number of mistakes and type of mistakes made in My Test are indicated at the bottom of the piece.

Extraordinary in My Test is the fact that test contents may be created using the mistakes and unknown words and phrases in the other tools of My Language Toolbox. My Test may also use any independent test material that may be used alone or in combination with the mistakes and unknown words and phrases. In addition, after the test is corrected the incorrect answers in the test along with the corresponding correct answers may be transferred to other tools for the learning of the mistakes.

For example, the test question is “How will the company be able to ______ for all of the red ink this past year?” and answers are “a. verbalize, b. account, c. distinguish, d. add”. If the student selects an incorrect answer such as “a. verbalize” as their answer, then the word “verbalize” and the correct answer “b. account” may be transferred to My dictionary, My grammar, My writing and the other tools. Further analysis of the test question by the software or instructor may reveal that the student does not understand the phrase “be able to” and the term “red ink” in the question. These unknown words and phrases are also then transferred to the other tools for leaning.

### Material for Reporting and Analyzing Progress

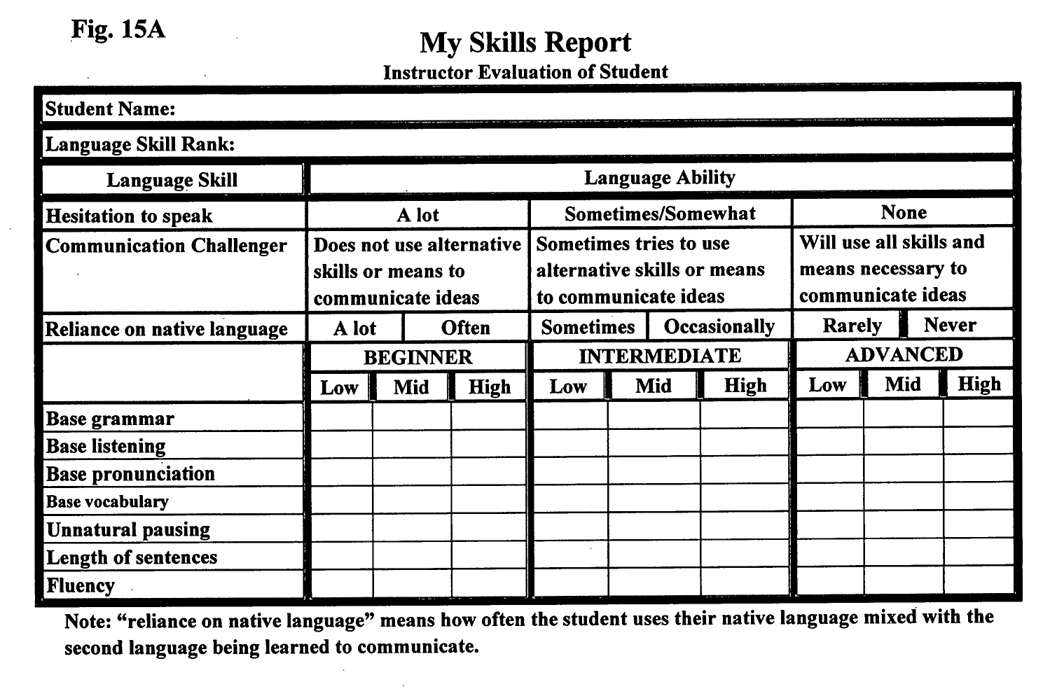

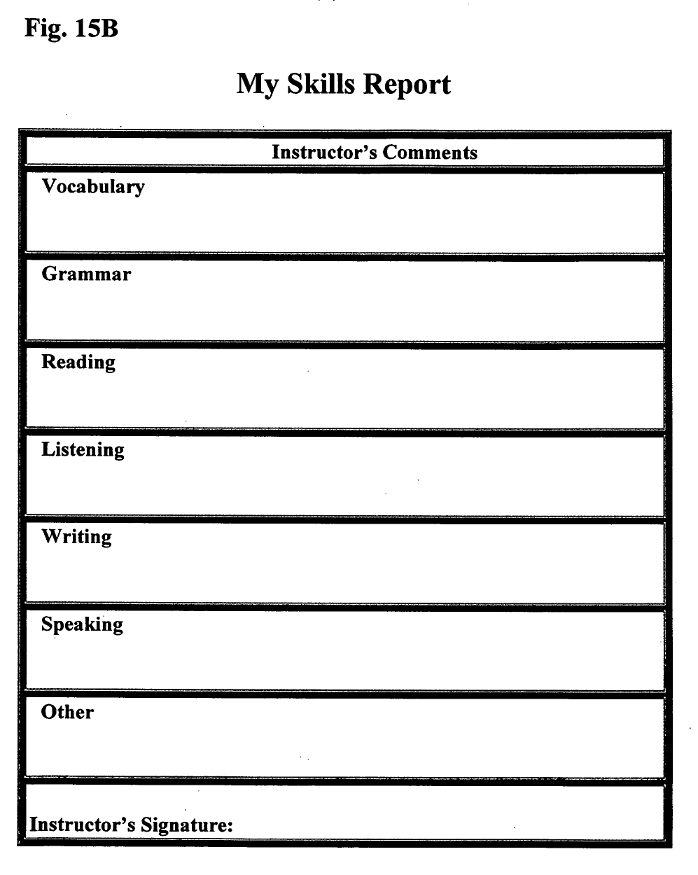

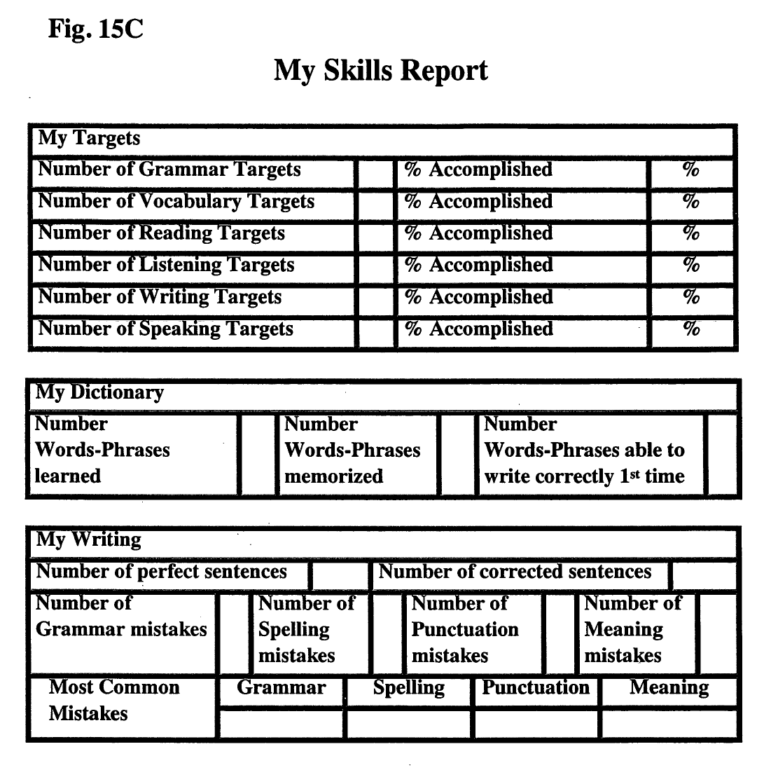

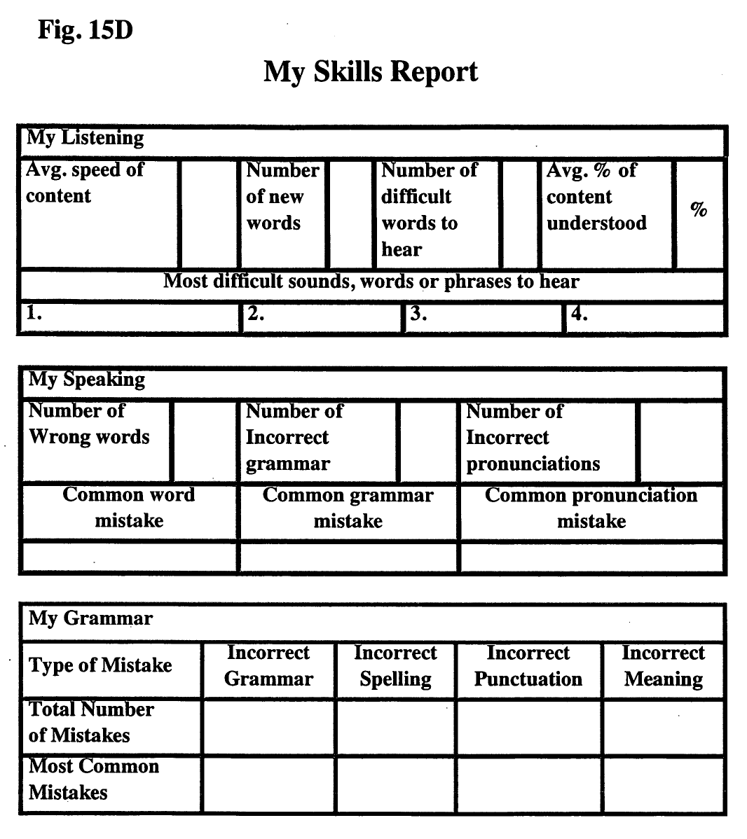

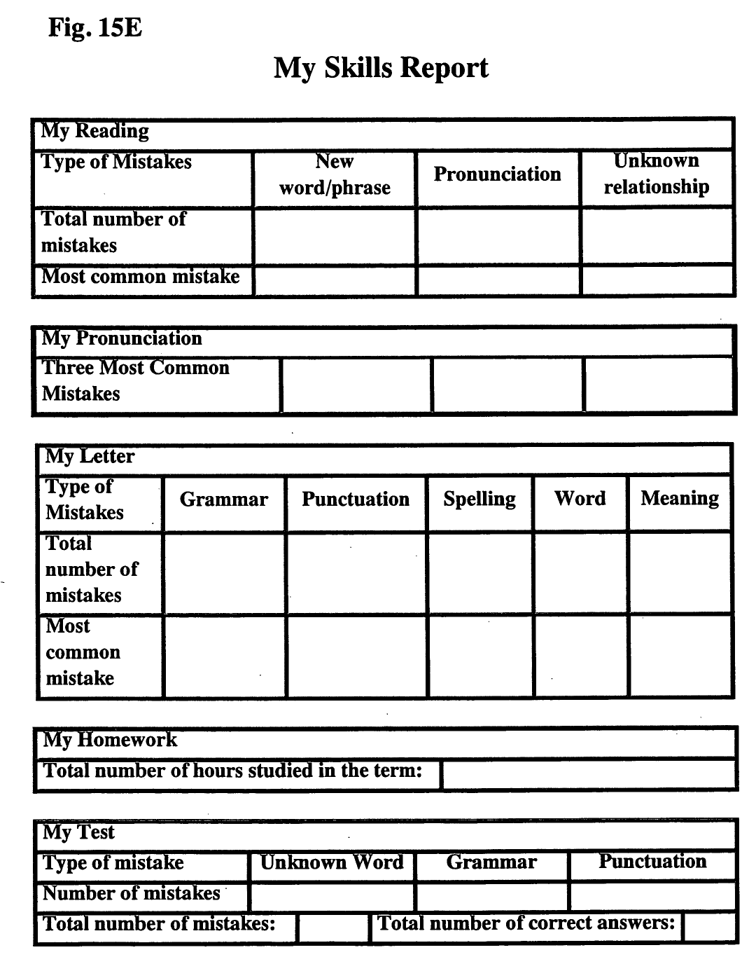

My Skills Report of FIGS. 15A to 15E show preferred embodiments of the material for reporting and analyzing a progress.

My Skills Report provides information about the students' language skills from the instructor. It also provides information derived from each of the materials such as the most common mistakes in a skill area among others. The reported information provides a significant advancement in allowing the student to understand their performance during the term of study, language capabilities and mistakes. It also is invaluable in helping to choose new targets and areas of study in future studies of the language and enables studies to focus on the students' weaknesses to develop stronger language skills.

### Single and Combination Use

In the round, all of the learner-making dictionary and materials mentioned above include at least the implementing section and the correcting section of elementary features of language commands such as writing ability, reading comprehension, listening comprehension and speaking ability. Each dictionary and material may be used separately if needed. In the case of single use, it has a significant advantage as the tool is personalized for a student and meets that student's particular needs. In this case, it is of great advantage for the student to be able to use the tool or tools selected by or for the student that are relevant only to his or her language study.

In addition, at least two of the dictionary and the materials may be selected and used together. The examples of preferable combination of using together are as follows; My English Targets and My Skills Reports; My Homework and My Skills Reports; My Dictionary and at least one of My Grammar, My Pronunciation, My Writing, My Letter, My Speaking Mistakes, My Test and My Skills Report; My Speaking Mistakes and at least one of My Dictionary, My Grammar, My Pronunciation, My Writing, My Letter, My Test and My Skills Report; My Listening and at least one of My Dictionary, My Grammar, My Pronunciation, My Writing, My Letter, My Test, My Speaking Mistakes and My Skills Report; My Reading and at least one of My Dictionary, My Grammar, My Pronunciation, My Writing, My Letter, My Speaking Mistakes, My Test and My Skills Report; My Grammar and at least one of My Dictionary, My Pronunciation, My Writing, My Letter, My Speaking Mistakes, My Test and My Skills Report; My Pronunciation and at least one of My Dictionary, My Grammar, My Writing, My Letter, My Speaking Mistakes and My Skills Report; My Writing and at least one of My Dictionary, My Grammar, My Pronunciation, My Letter, My Speaking Mistakes, My Test and My Skills Report; My Letter and at least one of My Dictionary, My Writing, My Grammar, My Pronunciation, My Speaking Mistakes, My Test and My Skills Report; My Test and at least one of My Dictionary, My Writing, My Grammar, My Letter, My Pronunciation, My Speaking Mistakes and My Skills Report.

It goes without saying that the tool contains all of the learner-making dictionary and materials is a preferable embodiment, and the combination of all the learner-making dictionary and materials may be well organized. In this case, from the mistakes and analysis made in Speaking, Listening, and Material for writings new words, phrases, and language mistakes are pulled and applied in My Dictionary to facilitate the learning and memorization of the new words, phrases and mistakes by translating, memorizing and using them in original sentences of which mistakes are corrected and categorized. Specific words, phrases, and mistakes from My Dictionary may also be pulled out and transferred to other tools for additional learning and memorization.

### Forms of the Tool

The tool of the present invention may be provided in various forms such as paper-based materials, electronic devices, software, internet web page, internet web site, organized light, graphic images, quantum computation, or digital or analogue data.

Using electronic devices the tools are automatically interactive with data being easily shared between tools and enables automatic analysis and tabulation of mistakes. Electronic devices also enable storage, manipulation, and display of all data as well as recording and play of verbal speech.

### Use of the Tool

There is thought to be at least two steps for acquiring foreign languages, learning the unknown word, the unknown phrase and the mistake; and memorizing the unknown word, the unknown phrase and the mistake.

At the learning step, the learner-created dictionary may be used to record and translate, unknown words or phrases, all centered around learning the unknown word or phrase and its meaning.

At the memorizing step, the learner-created dictionary may be used to facilitate memory of the unknown word or phrase by displaying the translation and prompting for the unknown word or phrase in the language being studied or vice versa. Upon being memorized, the unknown word or phrase is check as “OK” in the checkbox. Only memorized words or phrase may be checked off.

In addition to the above steps, the step of implementing the unknown word, the unknown phrase and the mistake is also important for acquiring foreign languages. At the implementing step the learner-created dictionary may be used to teach how the unknown word or phrase is implemented in the language. To do this, the student incorporates the unknown word or phrase in an original sentence and any mistake in the sentence is identified and categorized. A corrected version of the sentence is reproduced to show the correct usage of the unknown word or phrase.

By employing the method of the present invention, in learning listening skills, achieved is identification of what the student cannot hear is made, rather, only that the student failed to answer a question about the content correctly. Further, effective analysis is made of why the student did not hear the content and identification of what could not be heard and why it could not be heard, and record of those obstacles to hearing are kept or reapplied for further learning of new words and phrases.

By employing the method of the present invention, speaking, listening, and writing mistakes are identified in a class, are corrected by an instructor; with record of identification, correction, categorization and reapplication of mistakes exist.

By employing the method of the present invention, writing mistakes are corrected in a class with recorded on a sentence-by-sentence basis, with the mistakes categorized and reapplied to learn and memorize the specific corrected mistakes in grammar, vocabulary and punctuation.

1. A tool for acquiring a foreign language, comprising at least one of:
a material to set a target of study;
a material to make a plan of study;
a learner-making dictionary; a material for speaking; a material for listening; a material for pronunciation; a material for grammar; a material for writing; a material for a letter; a material for reading; in order to record, identify, analyze, correct, learn, memorize and use an unknown word, an unknown phrase and a mistake;
a material for motivating, tracking and confirming an independent study;
a material for testing a skill, the unknown word, the unknown phrase and the mistake; and
a material for reporting and analyzing a progress.

2. The tool according to claim 1, wherein all of the materials are contained and at least two of the materials are connected so that the unknown word, the unknown phrase and the mistake in at least one of the materials appear on at least one of the other materials.

3. The tool according to claim 1, wherein at least one of the materials utilize an electronic device.

4. The tool according to claim 1, wherein at least one of the materials comprise an implementing section and a correcting section of the unknown word, the unknown phrase and the mistake.

5. A method for acquiring a foreign language using the tool according to one of claims 1 to 4, comprising at least one of:
setting the target of study using the material to set the target of study;
making the plan of study using the material to make the plan of study;
recording, identifying, analyzing, correcting, learning, memorizing and using the unknown word, the unknown phrase and the mistake; using at least one of the learner-making dictionary, the material for speaking, the material for listening, the material for pronunciation, the material for grammar, the material for writing, the material for the letter and the material for reading;
motivating, tracking and confirming the independent study using the material for motivating, tracking and confirming the independent study;
testing the skill, the unknown word, the unknown phrase and the mistake using the material for testing the skill, the unknown word, the unknown phrase and the mistake; and
reporting and analyzing the progress using the material for reporting and analyzing the progress.
